(19) United States
(12) Patent Application Publication
(10) Pub. No.: US 2015/0019978 A1
(43) Pub. Date: Jan. 15, 2015

(54) INFORMATION PROCESSING APPARATUS, INFORMATION PROCESSING METHOD, AND PROGRAM

(71) Applicant: Sony Corporation, Tokyo (JP)

(72) Inventor: Masato Shimakawa, Kanagawa (JP)

(73) Assignee: Sony Corporation, Tokyo (JP)

(21) Appl. No.: 14/383,929

(22) PCT Filed: Jan. 30, 2013
(86) PCT No.: PCT/JP2013/000489

§ 371 Date: Sep. 9, 2014

(30) Foreign Application Priority Data
Mar. 28, 2012 (JP) 2012-073376

(51) Int. Cl. H04L 12/24; G06F 3/0482

(52) U.S. Cl. CPC H04L 41/0806; H04L 41/22; G06F 3/0482; H04W 84/12
USPC 715/735

(57) ABSTRACT

[Object] To allow a user to correctly confirm a device to be subjected to setting in an initial setup for wireless communication.

[Solving Means] An information processing apparatus includes a communication unit, an output unit, an operation receiving unit and a controller. The communication unit is capable of communicating with a device to be subjected to setting, which is a candidate for an initial setup for operating on a wireless communication network. The controller is capable of controlling the communication unit to search for the device to be subjected to setting; controlling the output unit to output a user interface showing a list of information relating to the retrieved devices to be subjected to setting; and controlling the operation receiving unit to accept the user's operation to select, from the output list, the device to be subjected to the initial setup.

### TECHNICAL FIELD

The present disclosure relates to an information processing apparatus capable of connecting to a wireless LAN (Local Area Network), and an information processing method and a program of the information processing apparatus.

### BACKGROUND ART

From the past, in using wireless LANs (IEEE 802.11, etc.), in order that a client device may connect to an access point and perform communication, there has been a need of setting for registering the client device to the access point. Specifically, there is a need of setting to configure SSID (Service Set Identifier), encryption scheme (WEP, WPA and WPA2, etc.) and passphrase for encryption, and the like.

For example, there is WPS (Wi-Fi Protected Setup) as a standard that provides a scheme and procedures for setting up wireless connections and securities in an easy way (for example, see Patent Document 1). Even with an embedded device which lacks a displaying function and an operation interface, the above-mentioned setting can be easily made by installing a WPS function to the embedded device. The schemes of setting by WPS include push-button scheme, PIN entering scheme and the like.

According to the push-button scheme, the setting can be completed by pressing dedicated buttons (hardware or software) that are each installed on the access point and the wireless client, at the same time (or, within a certain period after one of them has been pressed).

The PIN entering schemes include one in which the setting can be completed by entering, to the wireless client, a four-digit or eight-digit PIN code of the access point; one in which the setting can be completed by entering, to the access point, a PIN code (four to eight digits) of the wireless client; and the like.

Among these schemes, the easiest way to make the setting is the push-button scheme. In the push-button scheme, the access point and the wireless client each gives a notice that the button thereof has been pressed, over the wireless network by broadcast. If the access point confirms that only one set of access point and wireless client has had their buttons pressed within a certain period of time, the access point would send information that is necessary for performing encrypted communication, to the wireless client.

Patent Document 1: Japanese Patent Application Laid-open No. 2011-139199

### SUMMARY OF INVENTION

### Problem to be Solved by the Invention

However, the push-button scheme described above might have the following security problems.

In the above scheme, targets to be connected are decided only by the timing at which the buttons of the access point and the wireless client are pressed. Because of this, in cases where a third person presses a button of another wireless client at the same timing, although depending on the timing, there is a possibility that the access point might send the setting information to the wireless client that belongs to the third person, and that this might occur unnoticed by the user.

Similarly, in cases where a third person presses a button of another access point at the same timing as that when a user presses the buttons of the access point and the client device, although depending on the timing, there is a possibility that the user's wireless client might be connected to the other access point, and that this might occur unnoticed by the user.

From the nature of the action of pressing the buttons at the same time, the above-mentioned problem may be rare in practice. However, this may still allow a third person to use, by modifying own access point and wireless client, a modified device to automatically repeat the processing equivalent to the operation of pressing the button. This case may lead to an increase in the probability of success of frauds.

In view of the above-mentioned circumstances, an object of the present disclosure to provide an information processing apparatus, an information processing method, and a program capable of allowing a user to correctly confirm a device to be subjected to setting in an initial setup for wireless communication.

### Means for Solving the Problem

To solve the above-mentioned problem, an information processing apparatus according to an embodiment of the present disclosure includes a communication unit, an output unit, an operation receiving unit and a controller. The communication unit is capable of communicating with a device to be subjected to setting. The device to be subjected to setting is a candidate for an initial setup for operating on a wireless communication network. The controller is capable of controlling the communication unit to search for the device to be subjected to setting. Further, the controller is capable of controlling the output unit to output a user interface showing a list of information relating to the retrieved devices to be subjected to setting. Still further, the controller is capable of controlling the operation receiving unit to accept an operation by a user to select, from the output list, the device to be subjected to setting for the initial setup.

With this configuration, the information processing apparatus is capable of allowing the user to correctly confirm the device to be subjected to setting in the initial setup for wireless communication, by outputting the list of devices to be subjected to setting and allowing the user to select the device. The output unit may typically be a display unit. The output unit may be one which generates display information and outputs (sends) it to an external display device.

The controller may control the communication unit to send, to the selected device to be subjected to setting, a message requesting for approval for the initial setup, and receive, from the selected device to be subjected to setting, a message indicating the approval. The controller may control the output unit to output a piece of information indicating the approval.

With this configuration, the information processing apparatus is capable of allowing the user to surely confirm the device to be subjected to setting, by obtaining approval for the initial setup by the device to be subjected to setting and outputting that state.

The communication unit may be capable of communicating with an access point which stores setting information that is necessary for performing the initial setup. In this case, the controller may control the communication unit to send, to the access point, a message requesting for sending the stored setting information to the device to be subjected to setting.

With this configuration, the information processing apparatus is capable of executing registration processing between the access point and the device to be subjected to setting easily and surely, by instructing the access point to send the setting information. Examples of the setting information include SSID, encryption key (passphrase), and the like.

The information processing apparatus may further include a storage unit which stores setting information that is necessary for performing the initial setup. In this case, the controller may control the communication unit to encrypt and send the stored setting information to the selected device to be subjected to setting.

With this configuration, the information processing apparatus is capable of executing registration processing for registering the device to be subjected to setting in the access point easily and surely, by sending the setting information that the information processing apparatus has on its own, to the device to be subjected to setting. The information processing apparatus in this case may be an access point that would be used in wireless communication by the device to be subjected to setting; or may be a device after setting, which is different from an access point.

The controller may control the output unit to output, on the user interface, text information or image information which can allow the user to identify the device to be subjected to setting.

With this configuration, the information processing apparatus is capable of allowing the user to surely grasp the device to be subjected to setting, by providing the text information (model name, name of the device, etc.) or the image information (picture, illustration, icon, etc.).

The communication unit may be capable of communicating with a server on the network, which server stores the text information or the image information. In this case, the controller may control the communication unit to receive the text information or the image information from the server.

With this configuration, even in cases where the information processing apparatus does not have on its own the information relating to the device to be subjected to setting, the information processing apparatus is capable of outputting the list of devices to be subjected to setting, by using such information by obtaining it from the server.

The communication unit may be capable of communicating with a device after setting, the initial setup of which has been completed. In this case, the controller may control the output unit to output the information relating to the device to be subjected to setting and information relating to the device after setting, in a distinguishable manner, on the user interface.

With this configuration, the information processing apparatus is capable of allowing the user to easily grasp the device after setting and a device which is not set yet. This can prevent a user's useless operation or wrong operation.

The controller may control the communication unit to, if the operation to select is accepted, send a message requesting for outputting information that can be perceived by the user, to the selected device to be subjected to setting.

With this configuration, the user is able to easily specify the device to be subjected to setting, by perceiving the information output by the device to be subjected to setting. Such an effect may be useful especially in an environment where a number of devices similar to the device to be subjected to setting exist in the neighborhood.

The device to be subjected to setting may have a light-emitting part. In this case, the controller may control the communication unit to send, to the selected device to be subjected to setting, a message requesting for changing a state of the light-emitting part.

With this configuration, the user is able to specify the device to be subjected to setting, more easily, by recognizing a change in the state of the light-emitting part. The change in the state of the light-emitting part may mean, for example, a change from lighting-off state to lighting state or blinking state, a change in blinking patterns, or the like. The light-emitting part may be, for example, a LED display, but is not limited thereto.

The device to be subjected to setting may have a speaker. In this case, the controller may control the communication unit to send, to the selected device to be subjected to setting, a message requesting for outputting a predetermined sound from the speaker.

With this configuration, the user is able to specify the device to be subjected to setting, more easily, by recognizing the sound output from the speaker. The predetermined sound may be, for example, a sound which is output after a soundless state, or may be a sound with its pattern (melody) being changed from a previously-output sound.

The controller may control the output unit to output, on the user interface, an image representing a view of a state where the information that can be perceived is output from the device to be subjected to setting.

With this configuration, the user is able to easily grasp which device that performs what kind of operation the selected device to be subjected to setting is.

The device to be subjected to setting may have a button. In this case, the controller may control the communication unit to receive, from the selected device to be subjected to setting, a message notifying that the button has been pressed. Further, the controller may control the output unit to output, on the user interface, an image representing a view of a state where the button of the selected device to be subjected to setting is pressed.

With this configuration, the user is able to confirm that the desired device to be subjected to setting is correctly selected, by pressing the button of the device to be subjected to setting and confirming what it is on the user interface.

The communication unit may be capable of communicating with a server on the network, which server mediates cooperation processing between the information processing apparatus and the device to be subjected to setting. In this case, the controller may control the output unit to output, by using the user interface that shows the list, a user interface for performing association setting between the information processing apparatus and the device to be subjected to setting, the association setting being necessary in starting the cooperation processing, after completing the initial setup.

With this configuration, the information processing apparatus is able to allow the user to make the initial setup for wireless communication and the setting for device cooperation mediated by the server, at the same time with the same user interface. This would increase the convenience.

An information processing method according to another embodiment of the present disclosure includes searching for a device to be subjected to setting which is a candidate for an initial setup for operating on a wireless communication network. A user interface showing a list of information relating to the retrieved devices to be subjected to setting is output. Further, an operation by a user to select from the output list the device to be subjected to setting for the initial setup is accepted.

A program according to still another embodiment of the present disclosure causes an information processing apparatus to execute the steps of searching, outputting, and accepting an operation. In the searching, a device to be subjected to setting which is a candidate for an initial setup for operating on a wireless communication network is searched for. In the outputting, a user interface showing a list of information relating to the retrieved devices to be subjected to setting is output. In the accepting, an operation by a user to select from the output list the device to be subjected to setting for the initial setup is accepted.

### Effect of the Invention

As described above, according to the present disclosure, it is possible to allow the user to correctly confirm the device to be subjected to setting in the initial setup for wireless communication.

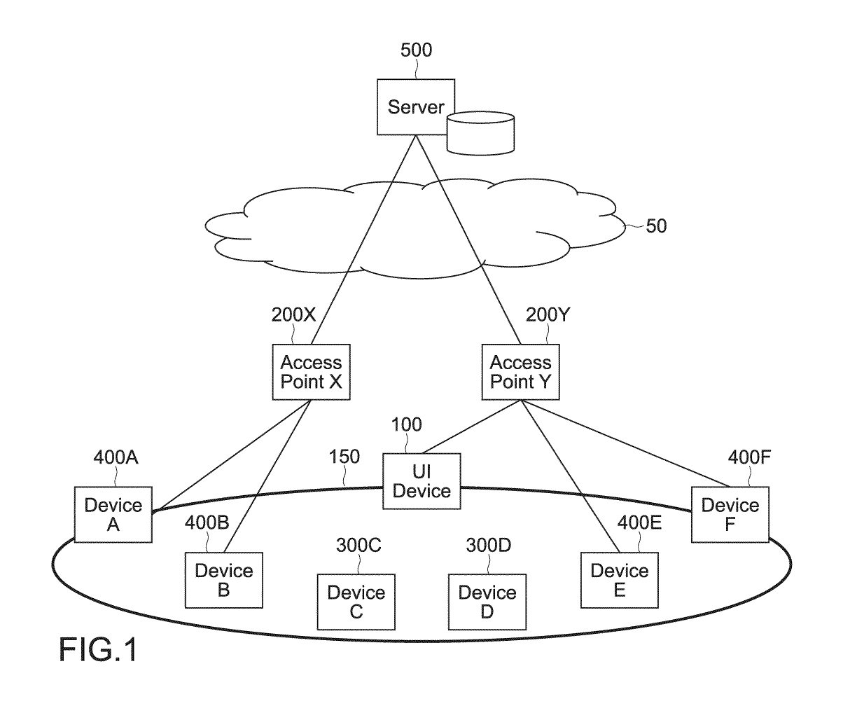

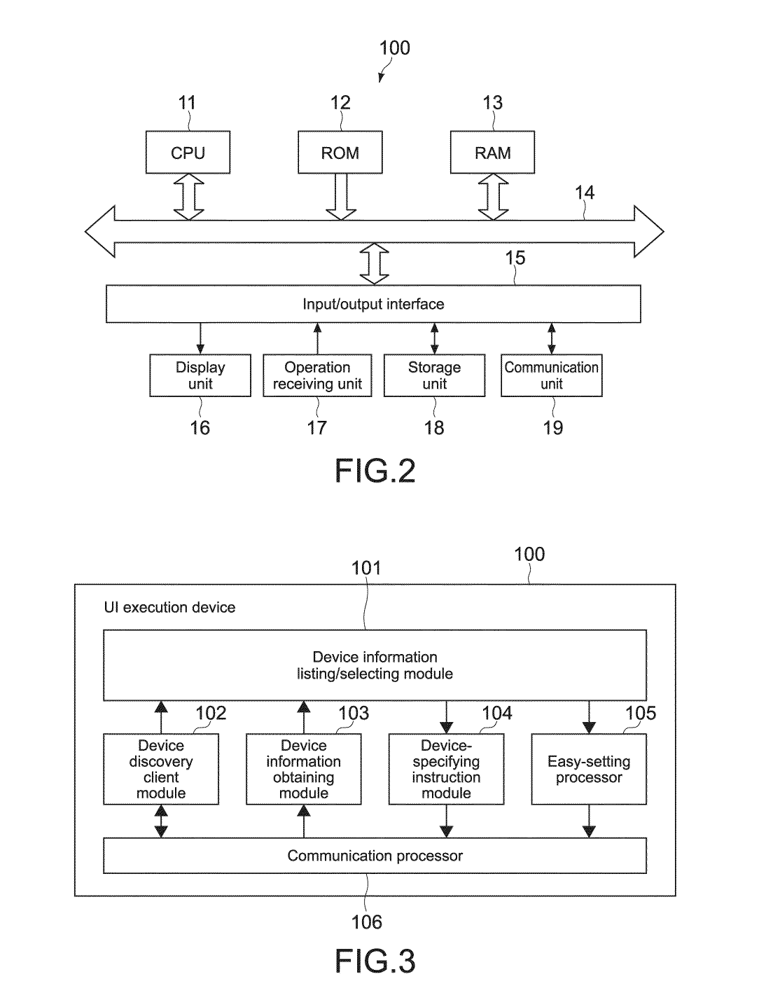

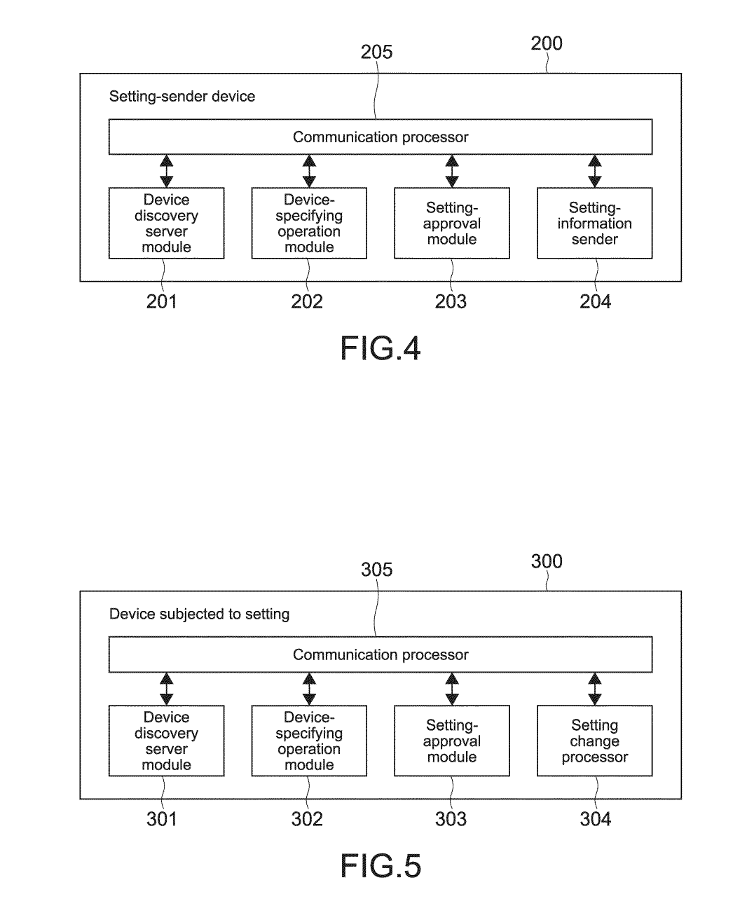

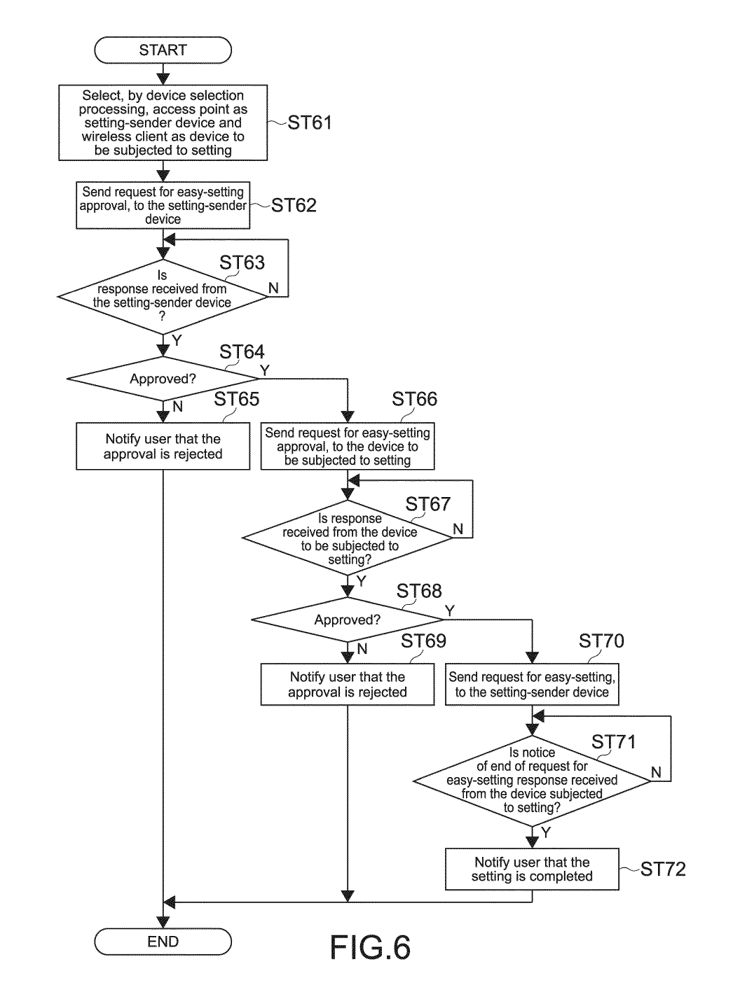

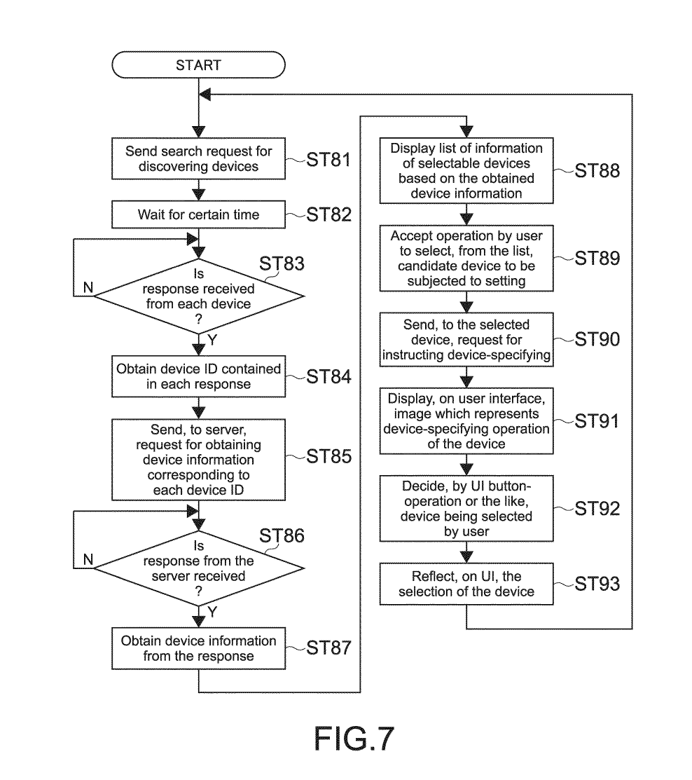

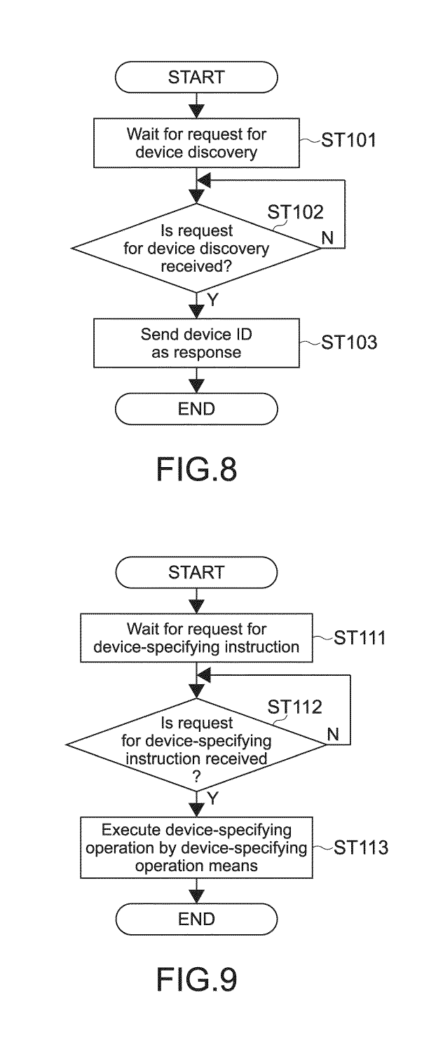

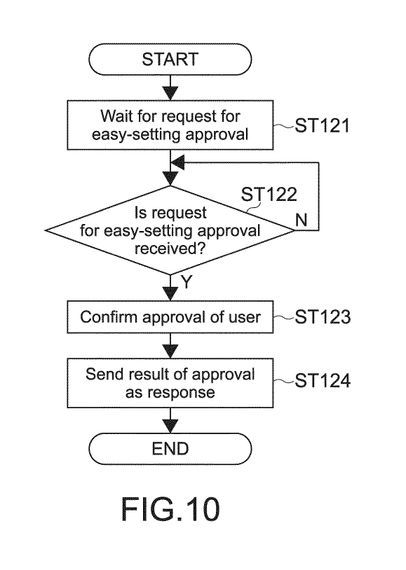

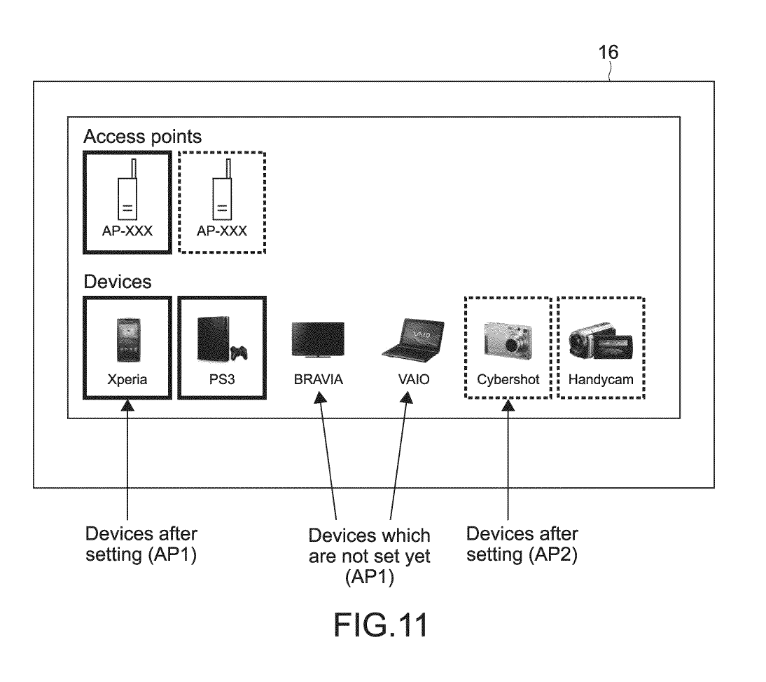

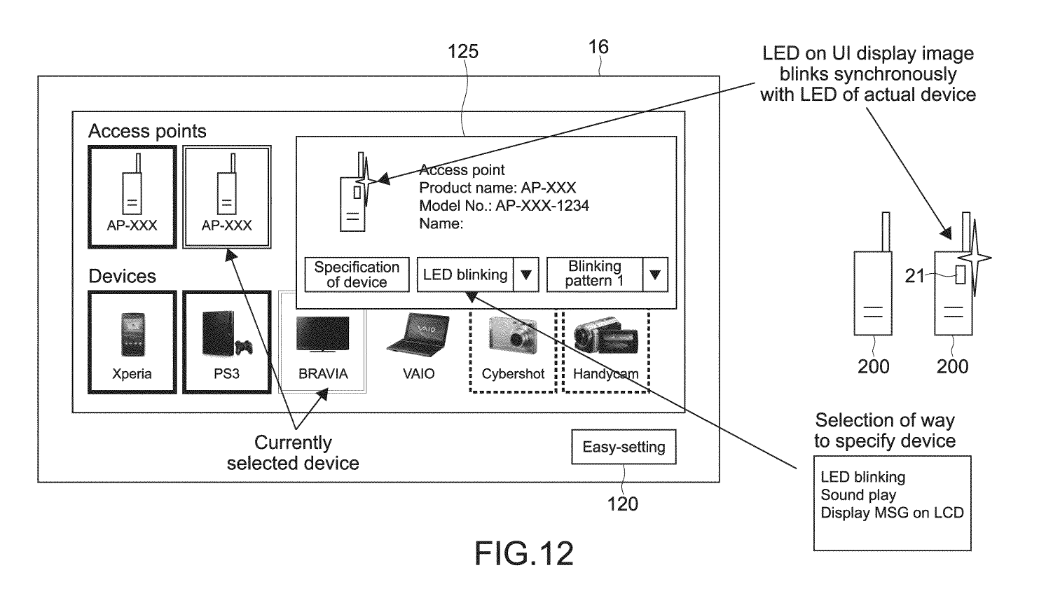

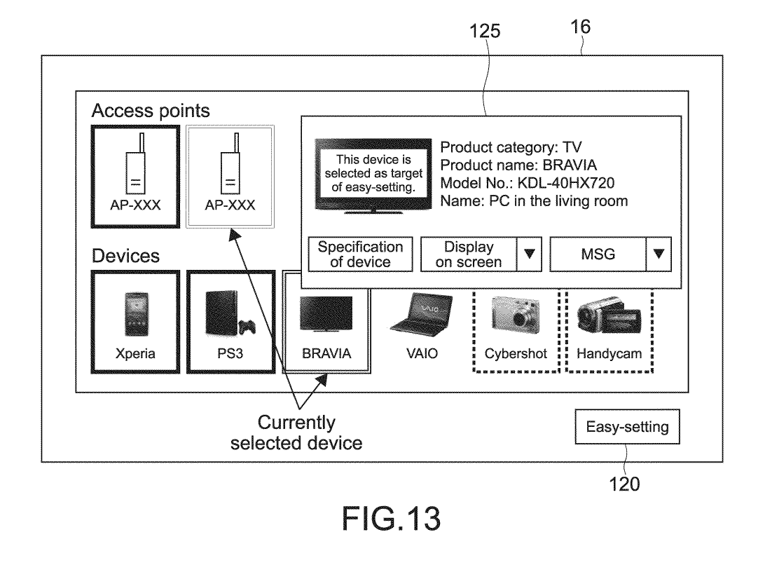

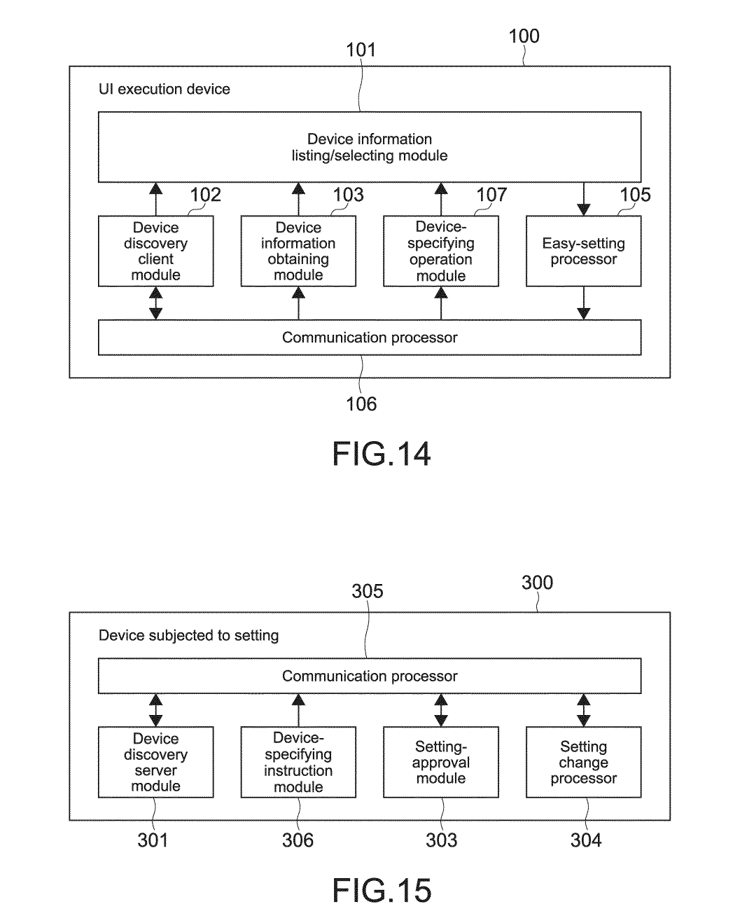

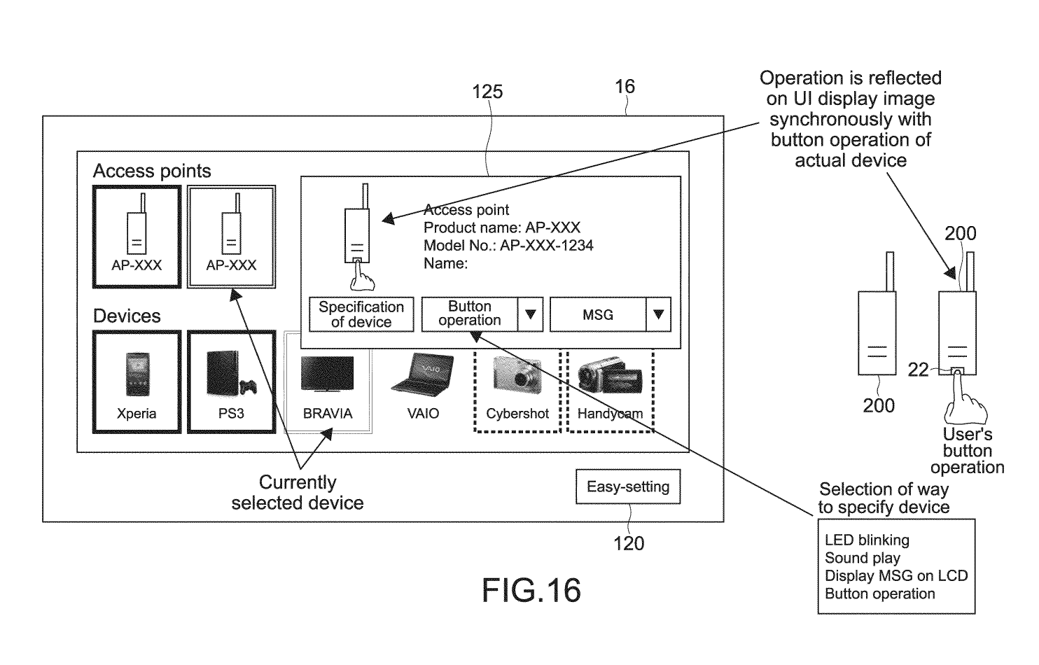

### BRIEF DESCRIPTION OF DRAWINGS

[FIG. 1] A diagram showing the network configuration of a system of a first embodiment of the present disclosure.

[FIG. 2] A block diagram showing the hardware configuration of a UI execution device of the above-mentioned system.

[FIG. 3] A block diagram showing the configuration of the software modules of the UI execution device of the above-mentioned system.

[FIG. 4] A block diagram showing the configuration of the software modules of a setting-sender device of the above-mentioned system.

[FIG. 5] A block diagram showing the configuration of the software modules of a device subjected to setting of the above-mentioned system.

[FIG. 6] A flowchart showing the flow of easy-setting processing by the UI execution device.

[FIG. 7] A flowchart showing the flow of device selection processing in the easy-setting processing.

[FIG. 8] A flowchart showing the flow of device discovery server-processing performed by the setting-sender device and the device subjected to setting.

[FIG. 9] A flowchart showing the flow of device-specifying processing performed by the setting-sender device and the device subjected to setting.

[FIG. 10] A flowchart showing the flow of easy-setting approval confirmation processing performed by the setting-sender device and the device subjected to setting.

[FIG. 11] A figure showing a display example of a user interface showing a list of information of selectable devices.

[FIG. 12] A figure showing an example of device-specifying operation; and a display example of an image corresponding to the operation, displayed on the user interface.

[FIG. 13] A figure showing another display example of an image corresponding to the operation, displayed on the user interface.

[FIG. 14] A block diagram showing the configuration of the software modules of a UI execution device of a variation example of the present disclosure.

[FIG. 15] A block diagram showing the configuration of the software modules of a device subjected to setting of a variation example of the present disclosure.

[FIG. 16] A figure showing an example of device-specifying operation of a variation example of the present disclosure.

### MODES FOR CARRYING OUT THE INVENTION

Hereinafter, an embodiment of the present disclosure will be described with reference to the drawings.

[Network Configuration of System]

FIG. 1 is a diagram showing the network configuration of a system of this embodiment.

As shown in FIG. 1, the system includes a server 500 in a cloud (WAN 50), a plurality of devices capable of connecting to the server 500 via a wireless LAN 150, and access points 200 which connect each of the devices to the server 500.

The device may be any information processing apparatus such as, for example, a smartphone, a mobile phone, a tablet PC (Personal Computer), a desktop PC, a laptop PC, a PDA (Personal Digital Assistant), a mobile AV player, an E-book reader, a digital still camera, a camcorder, a television set, a PVR (Personal Video Recorder), a video game console, a projector, an automotive navigation system, a digital photo frame, an HDD (Hard Disk Drive) device, a health-care device, and a home appliance.

To connect each device to the server 500 via an access point 200; each device needs to undergo an initial setup for connection and security, in order that the device may be registered as a wireless client with respect to the access point 200.

In the figure, the devices after undergoing the initial setup are referred to as “devices after setting 400”; and the devices that have not undergone the setup yet, that is, the devices each of which is a candidate device for setting, are referred to as “devices to be subjected to setting 300”.

Among the devices after setting, a device that executes (shows) a user interface (UI), for setting between the access point 200 and the device to be subjected to setting 300, is specifically referred to as a “UI execution device 100”. Examples of the UI execution device 100 include a smartphone, a PC, and the like.

In the initial setup processing of a wireless LAN in this embodiment, necessary information for setting (SSID, encryption passphrase, etc.) is sent from the access point 200 to the device to be subjected to setting 300. In view of this, the access point 200 of this embodiment will also be referred to as a “setting-sender device 200”. Furthermore, while the access points are setting-sender devices 200, since the access points can be considered also as targets of the above-mentioned initial setup processing, the access points may also serve as the above-mentioned “devices to be subjected to setting”.

In this embodiment, the setting-sender device 200, the device to be subjected to setting 300, and the device after setting 400 may also be simply referred to as a “device” without distinctions.

In the example shown in FIG. 1, the devices after setting 400A and 400B have undergone the setting to use the access point 200X. The devices after setting 400E and 400F have undergone the setting to use the access point 200Y. The devices to be subjected to setting 300C and 300D have not undergone registration with any access point yet.

The devices after setting 400 are capable of communicating with each other and cooperatively operating by using the server 500 in the cloud.

When each device after setting 400 is booted, each device establishes constant connection to the server 500. At this time, each device after setting 400 notifies the server 500 of the device ID uniquely assigned to each device after setting 400, and the server 500 mediates communication between the devices after setting 400 based on the device IDs.

The communication at this time is established based on messages (packets), and the device ID or the like is used to determine a destination or the like. If possible, communication between the devices after setting 400 may be made by P2P communication in order to reduce the load imposed on the server 500. In this P2P communication, the wireless LAN 150 may be used.

The server 500 stores information relating to each device on the wireless LAN 150 (model name, name of the device, icon, image, etc.).

In this embodiment, the UI execution device 100 is capable of allowing a user to conduct initial setup processing for the wireless LAN by easy operation, which processing is necessary as preprocessing which precedes cooperation processing between the devices after setting 400 mediated by the server 500. In this light, in this embodiment, this initial setup processing may also be referred to as “easy-setting”.

[Hardware Configuration of Messaging Server]

FIG. 2 is a diagram showing the hardware configuration of the above-mentioned UI execution device 100. As shown in FIG. 2, the UI execution device 100 includes a CPU (Central Processing Unit) 11, a ROM (Read Only Memory) 12, a RAM (Random Access Memory) 13, an input/output interface 15 and a bus 14 connecting them to each other.

The CPU 11 as necessary accesses the RAM 13 and the like appropriately, performs various kinds of arithmetic processing, and generally controls all of the blocks of the UI execution device 100. The ROM 12 is a nonvolatile fixed memory storing firmware such as an OS and programs executed by the CPU 11 and various parameters. The RAM 13 is used as a work area and the like for the CPU 11, and temporarily stores the OS, various kinds of application software being executed, and various kinds of data being processed.

To the input/output interface 15, the display unit 16, the operation receiving unit 17, the storage unit 18, the communication unit 19, and the like are connected.

The display unit 16 is a display device employing, for example, an LCD (Liquid Crystal Display), an OELD (Organic ElectroLuminescence Display), a CRT (Cathode Ray Tube), or the like.

The operation receiving unit 17 may be, for example, a pointing device such as a mouse, or a keyboard, a touchpad or other input devices. If the operation receiving unit 17 is a touchpad, the touchpad and the display unit 16 may be structured integrally.

The storage unit 18 is a nonvolatile memory such as, for example, a HDD (Hard Disk Drive), a flash memory (SSD: Solid State Drive), and other solid-state memories. The storage unit 18 stores the above-mentioned OS, various kinds of application software, and various kinds of data. Specifically, in this embodiment, the storage unit 18 stores programs such as those of a plurality of software modules which will be described later.

The communication unit 19 may be a wireless-communication module for connecting to the wireless LAN 150 or a 3G network; or an NIC or the like for connecting to the WAN 50. The communication unit 19 is in charge of communication with the server 500, the setting-sender device 200, the device to be subjected to setting 300, and the device after setting 400.

[Hardware Configuration of Setting-Sender Device and Device to be Subjected to Setting]

Although not shown, basic hardware configuration of the above-mentioned setting-sender device 200 and that of the device to be subjected to setting 300 are similar to the above-mentioned hardware configuration of the UI execution device 100. However, such devices may also include those without the display unit and without the operation receiving unit.

In addition, the device to be subjected to setting 300 has hardware as a device-specifying operation means (e.g. LED display, speaker, liquid crystal display, etc.) for executing the device-specifying operation according to the UI execution device 100, which will be described later.

Further, the storage unit of the setting-sender device 200 stores the setting information such as SSID and encryption passphrase, which information would be necessary for easy-setting.

[Module Configuration of UI Execution Device]

FIG. 3 is a diagram showing the configuration of the software modules of the UI execution device 100. As shown in FIG. 3, the UI execution device 100 includes software modules, i.e., a device information listing/selecting module 101, a device discovery client module 102, a device information obtaining module 103, a device-specifying instruction module 104, an easy-setting processor 105 and a communication processor 106.

The device information listing/selecting module 101 lists the information relating to the setting-sender devices 200, the devices to be subjected to setting 300 and the devices after setting 400, on the user interface on the display unit 16. The device information listing/selecting module 101 also accepts an operation, on the user interface, of selecting the device to be subjected to setting 300 for which the user desires to perform setting.

The device discovery client module 102, by device search processing, sends a search request to each device in the neighborhood (within wireless LAN 150) and obtains device ID from the retrieved device.

The device information obtaining module 103 obtains device information of each device, from the server 500.

The device-specifying instruction module 104 instructs, to the device to be subjected to setting 300 that has been selected by the user, to execute an operation for allowing the user to specify that device (device-specifying operation).

The easy-setting processor 105 executes processing such as, sending requests for easy-setting approval to the setting-sender device 200 and the selected device to be subjected to setting 300; sending a request for easy-setting to the setting-sender device 200; and notifying the user of the approval and completion of setting, which processing would be necessary for easy-setting.

The communication processor 106 executes communication processing, which is necessary for each processing performed by the device discovery client module 102, the device information obtaining module 103, the device-specifying instruction module 104 and the easy-setting processor 105.

[Module Configuration of Setting-Sender Device]

FIG. 4 is a diagram showing the configuration of the software modules of the above-mentioned setting-sender device 200. As shown in FIG. 4, the setting-sender device 200 includes software modules, i.e., a device discovery server module 201, a device-specifying operation module 202, a setting-approval module 203, a setting-information sender 204 and a communication processor 205.

The device discovery server module 201 sends a response to the search request from the UI execution device 100. The response includes the device ID of its own.

The device-specifying operation module 202 executes the device-specifying operation by using given hardware, in response to the instruction of the device-specifying operation from the UI execution device 100.

The setting-approval module 203 sends a response (approved/rejected) to the request for approval for setting being sent from the UI execution device 100.

The setting-information sender 204 sends the setting information necessary for setting, to the device to be subjected to setting 300, in response to the request for setting from the UI execution device 100.

The communication processor 205 executes communication processing, which is necessary for each processing performed by the device discovery server module 201, the device-specifying operation module 202, the setting-approval module 203 and the setting-information sender 204.

[Module Configuration of Device Subjected to Setting]

FIG. 5 is a diagram showing the configuration of the software modules of the above-mentioned device to be subjected to setting 300. As shown in FIG. 5, the device to be subjected to setting 300 includes software modules, i.e., a device discovery server module 301, a device-specifying operation module 302, a setting-approval module 303, a setting change processor 304 and a communication processor 305.

The device discovery server module 301 sends a response to the search request from the UI execution device 100. The response includes the device ID of its own.

The device-specifying operation module 302 executes the device-specifying operation by using given hardware, in response to the instruction of the device-specifying operation from the UI execution device 100.

The setting-approval module 303 sends a response (approved/rejected) to the request for approval for setting being sent from the UI execution device 100.

The setting change processor 304 receives the setting information necessary for setting, which setting information is sent from the setting-sender device 200 in response to the request for setting from the UI execution device 100. The setting change processor 304 changes wireless LAN setting, based on the setting information.

The communication processor 305 executes communication processing, which is necessary for each processing performed by the device discovery server module 301, the device-specifying operation module 302, the setting-approval module 303 and the setting change processor 304.

[Operations of System]

Next, operations of the UI execution device 100, the setting-sender device 200 and the device to be subjected to setting 300 of the system configured as described above will be described. In this embodiment and other embodiments, operations of these devices are cooperatively executed by a CPU and each of the above-mentioned software modules which are controlled and executed by the CPU.

FIG. 6 is a flowchart showing the flow of easy-setting processing by the UI execution device 100. FIG. 7 is a flowchart showing the flow of device selection processing in the easy-setting processing. FIG. 8 is a flowchart showing the flow of device discovery server-processing performed by the setting-sender device 200 and the device to be subjected to setting 300. FIG. 9 is a flowchart showing the flow of device-specifying processing performed by the setting-sender device 200 and the device to be subjected to setting 300. FIG. 10 is a flowchart showing the flow of easy-setting approval confirmation processing performed by the setting-sender device 200 and the device to be subjected to setting 300.

First, the device information listing/selecting module 101 of the UI execution device 100 executes the device selection processing, and allows the user to select an access point which will be the setting-sender device 200 and a wireless client which will be the device to be subjected to setting 300 (FIG. 6, Step 61).

In this device selection processing, the device information listing/selecting module 101 sends by broadcast, by the device discovery client module 102, a search request for discovering devices (FIG. 7, Step 81).

Each device waits for the search request (FIG. 8, Step 101), and upon receiving the search request (Step 102), the device sends its own device ID as a response (Step 103).

The device discovery client module 102 waits for the response of devices for a certain time (Step 82), and upon receiving the response of each device (Step 83, Yes), the device discovery client module 102 obtains the device ID contained in the response (Step 84).

Then, the device information listing/selecting module 101 sends to the server 500, by the device information obtaining module 103, a request for obtaining the device information corresponding to each device ID being obtained (Step 85).

If the device information obtaining module 103 receives a response from the server 500 (Step 86, Yes), the device information listing/selecting module 101 obtains each device information from the response (Step 87).

Then, the device information listing/selecting module 101 generates a user interface showing a list of information of selectable devices based on the obtained device information, and displays it on the display unit 16 (Step 88).

FIG. 11 is a figure showing a display example of the user interface showing the list of information of selectable devices. As shown in FIG. 11, on this user interface, model names or the names of the devices, as well as icons or images (pictures) indicating the respective access points and devices which may be selected, are shown in list display, to be able to be selected by an operation of selection.

In this user interface, the devices after setting and the devices which are not set yet (devices to be subjected to setting) are displayed in a distinguishable manner. In addition, since there are two access points in this embodiment, the devices after setting are displayed in a form that shows which access point is set to be used by each device. In the example shown in FIG. 11, images of one access point and the devices being set thereto are surrounded by solid-line frames; and images of another access point and the devices being set thereto are surrounded by dashed-line frames. In this example, it is also possible to perform the processing to select which access point to register the device. In this light, the access points can be considered also as devices to be subjected to easy-setting.

Referring back to FIG. 7, the device information listing/selecting module 101 then accepts an operation by the user to select, on the above-mentioned user interface, the device to be subjected to setting which is a candidate for setting (Step 89). The operation of selection can be made by, for example, mouse-clicking; a touch operation or an operation to surround an icon with a finger or a stylus; or the like. The icon (picture) of the selected device to be subjected to setting may be, for example, surrounded by a frame having a different color, so that the user can know that the device is in a state of being selected.

Then, the device information listing/selecting module 101 sends by the device-specifying instruction module 104, to the selected device to be subjected to setting, a request for instructing device-specifying (Step 90).

The device-specifying operation module of the device to be subjected to setting waits for the request for device-specifying instruction (FIG. 9, Step 111), and upon receiving the request for device-specifying instruction (Step 112, Yes), the device executes the device-specifying operation by its own device-specifying operation means (Step 113).

Then, the device information listing/selecting module 101 displays on the user interface, synchronously with the device-specifying operation, an image representing a view of a state where the device-specifying operation is performed by the device to be subjected to setting, the device having been the destination of the request for device-specifying instruction (FIG. 7, Step 91).

FIG. 12 is a figure showing an example of the device-specifying operation and a display example of the image corresponding to the operation, displayed on the user interface.

As shown in the right part of FIG. 12, the device to be subjected to setting (i.e., the access point in this case) which has received the above-mentioned request for device-specifying instruction may, for example, allow a LED display 21 to blink in a predetermined pattern, the LED display 21 being mounted on the device. The LED display 21 may be in a lighting state as well, instead of blinking.

With this blinking processing of the LED display 21 as the device-specifying operation, the user is able to easily grasp which device is selected as the device to be subjected to setting. Specifically in cases as shown in FIG. 12 where the device to be subjected to setting which is not selected exists near the selected device to be subjected to setting and has a similar appearance to the selected device, it allows the user to grasp at a glance which device the selected device is.

Meanwhile, as shown in the left part of FIG. 12, the UI execution device 100 displays a device-specifying information display area 125 on the user interface. On the device-specifying information display area 125, an image representing a view, just as it is, of a state where the device-specifying operation is performed by the device to be subjected to setting, together with the model name, the name of the device, the name set by the user, and the like. With this image, an appearance of the device to be subjected to setting (i.e., the access point in the case of FIG. 12) and a position of the device-specifying means of the device (i.e., the LED display 21 in the case of FIG. 12), and even each state of the means (i.e., blinking in the case of FIG. 12) are reproduced as faithfully as possible.

In addition, on the device-specifying information display area 125, a pull-down menu for selecting the device-specifying operation of each device and the details thereof (action pattern, etc.) is also displayed. With the pull-down menu, as well as the blinking of the above-mentioned LED display 21, other device-specifying operations such as, playing a sound from the speaker, and displaying a message on the liquid crystal display, are also able to be selected and set for each device by the user.

The UI execution device 100 sends, to the device to be subjected to setting, the request for device-specifying instruction corresponding to the set device-specifying operation. In response to this, each device to be subjected to setting executes the device-specifying operation.

Further, the device information listing/selecting module 101 displays a setting confirmation button 120 on the user interface as well, at the time of displaying the device-specifying information display area 125. The setting confirmation button 120 is for confirming the selection of the device to be subjected to setting.

FIG. 13 is a figure showing another display example of an image corresponding to the device-specifying operation, displayed on the user interface.

As shown in FIG. 13, in this example, a television set is selected as the device to be subjected to setting, and an action of displaying a message on the liquid crystal display is set as the device-specifying operation. The device to be subjected to setting may respond to the above-mentioned request for device-specifying instruction by, for example, displaying the message saying “This device is selected as target of easy-setting.” or the like, on the liquid crystal display. Meanwhile, the UI execution device 100 displays, together with the model name, the name of the device, and the like, an image representing a view of a state where the above-mentioned message is displayed on the liquid crystal display of the device to be subjected to setting.

Although not shown, a similar operation would be performed if playing the sound from the speaker is selected and set as the device-specifying operation. That is, the device to be subjected to setting which has received the request for device-specifying instruction may play a melody being set to the device, from its own speaker. Meanwhile, The UI execution device 100 displays an image representing a view of a state where the speaker of the device to be subjected to setting plays the melody, on the device-specifying information display area 125.

Referring back to FIG. 7, the device information listing/selecting module 101 of the UI execution device 100 accepts the user's operation of pressing the setting confirmation button 120, or the like (Step 92).

Following this operation, the device information listing/selecting module 101 confirms the selection of the device as the device to be subjected to setting, and reflects the selection onto the user interface (Step 93). For example, the device information listing/selecting module 101 may display a message indicating the confirmation of the selection, and may display a message indicating that the subsequent processing of approval is in process.

In this embodiment, the above-mentioned processing of confirmation of selection is executed with respect to each of the device to be subjected to setting; and the access point as the setting-sender device.

Referring back to FIG. 6, if the device to be subjected to setting is confirmed, the easy-setting processor 105 of the UI execution device 100 sends a request for easy-setting approval to the setting-sender device 200 (Step 62).

The setting-approval module 203 of the setting-sender device 200 waits for the request for easy-setting approval (FIG. 10, Step 121), and upon receiving the request for easy-setting approval (Step 122, Yes), the setting-approval module 203 confirms the easy-setting approval of the user (Step 123). The setting-approval module 203 may, for example, display a message indicating that the request for approval has been received, a button for approval, and a button for rejection, on a display. The setting-approval module 203 may thus accept the user's operation on one of the buttons.

Then, the setting-approval module 203 sends a result of approval as a response, to the UI execution device 100 (Step 124).

If the easy-setting processor 105 of the UI execution device 100 receives the response from the setting-sender device 200 (FIG. 6, Step 63, Yes), it determines whether the result of approval indicated by the response is approval or rejection (Step 64).

If the above-mentioned result is the rejection (No), the easy-setting processor 105 notifies the user that the request for approval was rejected by the setting-sender device 200, via the display unit 16 (Step 65).

If the above-mentioned result is the approval (Yes), the easy-setting processor 105 sends the request for easy-setting approval to the device to be subjected to setting 300 (Step 66).

The setting-approval module 303 of the device to be subjected to setting 300 waits for the request for easy-setting approval (FIG. 10, Step 121), and upon receiving the request for easy-setting approval (Step 122, Yes), the setting-approval module 303 confirms the easy-setting approval of the user (Step 123) and sends a result of approval as a response (Step 124).

If the easy-setting processor 105 of the UI execution device 100 receives the response from the device to be subjected to setting 300 (FIG. 6, Step 67, Yes), it determines whether the result of approval indicated by the response is approval or rejection (Step 68).

If the above-mentioned result is the rejection (No), the easy-setting processor 105 notifies the user that the request for approval was rejected by the device to be subjected to setting 300, via the display unit 16 (Step 69).

If the above-mentioned result is the approval (Yes), the easy-setting processor 105 sends the request for easy-setting to the setting-sender device 200 (Step 70).

The setting-sender device 200, which has received the request for easy-setting, encrypts and sends the setting information such as SSID and encryption passphrase to the device to be subjected to setting 300, and allows the setting. Further, if the device to be subjected to setting 300 receives the setting information, the device performs setting with such information, and then notifies the UI execution device 100 that the processing in response to the request for easy-setting is completed.

If the easy-setting processor 105 receives, from the device to be subjected to setting 300, the notice of completion of the processing in response to the request for easy-setting (Step 71, Yes), the easy-setting processor 105 notifies the user that the easy-setting processing is completed, via the display unit 16 (Step 72).

[Conclusion]

As described above, according to this embodiment, the UI execution device 100 displays the list of the devices to be subjected to setting, on the user interface. Further, by the device to be subjected to setting being selected on the user interface by the user, the device-specifying operation is executed. Furthermore, on the user interface, the image representing the device-specifying operation is displayed.

Thus, the UI execution device 100 is able to allow the user to correctly confirm the device to be subjected to setting, and is able to surely execute the processing of setting.

### VARIATION EXAMPLES

The present disclosure is not limited to the above-mentioned embodiment, but may be variously changed within the gist of the present disclosure.

### Variation Example 1

In the above-mentioned embodiment, the UI execution device and the setting sender device (access point) are illustrated as independent devices. However, the UI execution device may be the same device as the setting sender device as well.

In this case, the processing by the above-mentioned device discovery server module 201, the device-specifying operation module 202 and the setting-approval module 203; and the processing regarding these modules on the UI execution device may be omitted. Further, the device which serves as the UI execution device and the setting sender device (e.g., access point) may send the setting information of its own, to the device to be subjected to setting.

Moreover, in this case, if the setting-sender device does not have a function of displaying the above-mentioned user interface, it is possible that the processing which only generates the user interface may be executed by the setting-sender device; and the processing of displaying it may be performed by another device. For example, as the user interface on the access point, the access point may serve as an HTTP server, while another device may execute a browser and display the user interface.

### Variation Example 2

Further, the UI execution device may be the same device as the device to be subjected to setting. In this case, the processing by the above-mentioned device discovery server module 301, the device-specifying operation module 302 and the setting-approval module 303; and the processing regarding these modules on the UI execution device may be omitted.

In this case, the device which serves as the UI execution device and the device to be subjected to setting displays the user interface, and, if there is a setting approval from the setting-sender device (e.g., access point), the device would receive the setting information from the setting-sender device.

### Variation Example 3

In the above-mentioned embodiment, the UI execution device is provided with the device-specifying instruction module 104; and corresponding to this, the device to be subjected to setting 300 and the setting-sender device 200 are respectively provided with the device-specifying operation module 302 and 202. However, opposite to this configuration, it is possible that the UI execution device may be provided with the device-specifying operation module while the device to be subjected to setting and the setting-sender device may be provided with device-specifying instruction modules. Further, it is also possible that each of the devices may have both the device-specifying instruction module and the device-specifying operation module.

FIG. 14 is a block diagram showing the configuration of the software modules of the UI execution device 100 in this case; and FIG. 15 is a block diagram showing the configuration of the software modules of the device to be subjected to setting 300 in this case.

As shown in FIGS. 14 and 15, in this case, the UI execution device 100 has a device-specifying operation module 107 in place of the device-specifying instruction module 104; and the device to be subjected to setting 300 has a device-specifying instruction module 306 in place of device-specifying operation module 302.

That is, in such a case, the device-specifying operation would be executed on the UI execution device 100 in response to the instruction from the device to be subjected to setting 300 or the setting-sender device 200. FIG. 16 is a figure showing an example of the device-specifying operation in such a case.

As shown in FIG. 16, the access point 200 as the device to be subjected to setting has a button 22. If this button is pressed by the user, the access point 200 would instruct for the processing of displaying the information that indicates the button operation (e.g., image representing pressing the button) as the device-specifying operation, to the UI execution device 100.

The UI execution device 100 displays the information that indicates pressing the button, as the device-specifying operation, on the device-specifying information display area 125. In this case, in the above-mentioned pull-down menu, the button operation is selectable as the device-specifying operation as well.

The user can confirm the image on the user interface after pressing the button 22 on the access point 200, and thus, can confirm the access point that the user has selected is correctly selected as the device to be subjected to setting.

### Variation Example 4

In the above-mentioned embodiment, the configuration by which the device to be subjected to setting can be grasped with more sureness by the user, with the execution of the device-specifying operation, is provided. However, for example, in an environment where the same kind of device does not exist and the device to be subjected to setting is able to be surely grasped according to the name of the device and the like being displayed on the user interface, there may be a device without the above-mentioned device-specifying instruction module or the device-specifying operation module.

### Variation Example 5

In the above-mentioned embodiment, the device to be subjected to setting and the setting-sender device are provided with the setting-approval modules, and the processing of approval is executed in the easy-setting processing. However, there may be a device without this setting-approval module. Further, depending on the user's setting or the like, each device may also omit the processing of approval as well in cases where the device is provided with the setting-approval module.

### Variation Example 5

In the above-mentioned embodiment, the device information is obtained from the server 500. However, it is also possible that each device instead of the server 500 may store the information relating to the own device (name of the device, model name, icon, picture, etc.) and provide it in response to the request.

### Variation Example 6

In the above-mentioned embodiment, the access point is also selected as the device to be subjected to setting. However, the processing of selection of the access point by the user may be omitted. In this case, the access point that the UI execution device has already set may be selected automatically.

### Variation Example 7

In the above-mentioned embodiment, after the execution of the easy-setting processing, it is also possible that processing of association setting of each device via the server 500 may be executed subsequently. In this association setting processing, a plurality of devices would be co-operably associated with each other, by previously executing authentication by providing an association between the server and, the user (user ID) and the device (device ID), and then allowing the user ID of the device after authentication, via the server 500, to be associated also to the device ID of another device.

For the user interface for performing the association setting, the same user interface as that used for the easy-setting processing may be used. For example, on the user interface of a setting-source device, a list of images or icons of other devices being retrieved by the device search processing may be displayed. If the user of the setting-source device selects the image or icon by an operation such as clicking, touching and surrounding the image or icon, a message requesting for association setting would be sent from the setting-source device to the selected other device via the server 500. If an operation of approving the request for setting is input to the other device, response information indicating this would be sent via the server 500 to the setting-source device. Then, on the display unit of the setting-source device, upon receiving the response information, a display form of the image or icon of the device where the setting is completed would be changed in the list. The completion of the association setting is notified to the user.

By making such an user interface for the association setting processing and the user interface for the easy-setting processing common, it allows the user to execute the easy-setting processing for wireless communication; and the association setting processing on the device where the easy-setting processing is completed and another device, in a series of operations at a time.

### Variation Example 8

In the above-mentioned embodiment, the wireless LAN is used as a wireless communication standard. However, the present disclosure may be applied to initial setup processing of wireless communication standards other than the wireless LAN as well.

[Others]

The present disclosure may employ the following configurations.

(1) An information processing apparatus including:

a communication unit capable of communicating with a device to be subjected to setting, the device to be subjected to setting being a candidate for an initial setup for operating on a wireless communication network;

an output unit;

an operation receiving unit; and

a controller capable of
controlling the communication unit to search for the device to be subjected to setting,
controlling the output unit to output a user interface showing a list of information relating to the retrieved devices to be subjected to setting, and
controlling the operation receiving unit to accept an operation by a user to select, from the output list, the device to be subjected to setting for the initial setup.
   (2) The information processing apparatus according to (1), in which

the controller
controls the communication unit to
   send, to the selected device to be subjected to setting, a message requesting for approval for the initial setup, and
   receive, from the selected device to be subjected to setting, a message indicating the approval, and
controls the output unit to output a piece of information indicating the approval.
   (3) The information processing apparatus according to (1) or (2), in which

the communication unit is capable of communicating with an access point which stores setting information that is necessary for performing the initial setup, and

the controller controls the communication unit to send, to the access point, a message requesting for sending the stored setting information to the device to be subjected to setting.

(4) The information processing apparatus according to any one of (1) to (3), further including

a storage unit which stores setting information that is necessary for performing the initial setup, in which

the controller controls the communication unit to encrypt and send the stored setting information to the selected device to be subjected to setting.

(5) The information processing apparatus according to any one of (1) to (4), in which

the controller controls the output unit to output, on the user interface, text information or image information which can allow the user to identify the device to be subjected to setting.

(6) The information processing apparatus according to (5), in which

the communication unit is capable of communicating with a server on the network, which server stores the text information or the image information, and

the controller controls the communication unit to receive the text information or the image information from the server.

(7) The information processing apparatus according to any one of (1) to (6), in which

the communication unit is capable of communicating with a device after setting, the initial setup of which has been completed, and

the controller controls the output unit to output the information relating to the device to be subjected to setting and information relating to the device after setting, in a distinguishable manner, on the user interface.

(8) The information processing apparatus according to any one of (1) to (7), in which

the controller controls the communication unit to,
if the operation to select is accepted,
send a message requesting for outputting information that can be perceived by the user, to the selected device to be subjected to setting.
   (9) The information processing apparatus according to (8), in which

the device to be subjected to setting has a light-emitting part, and

the controller controls the communication unit to send, to the selected device to be subjected to setting, a message requesting for changing a state of the light-emitting part.

(10) The information processing apparatus according to (8) or (9), in which

the device to be subjected to setting has a speaker, and

the controller controls the communication unit to send, to the selected device to be subjected to setting, a message requesting for outputting a predetermined sound from the speaker.

(11) The information processing apparatus according to any one of (8) to (10), in which

the controller controls the output unit to output, on the user interface, an image representing a view of a state where the information that can be perceived is output from the device to be subjected to setting.

(12) The information processing apparatus according to any one of (1) to (13), in which

the device to be subjected to setting has a button, and

the controller
controls the communication unit to send, to the selected device to be subjected to setting, a message requesting for outputting a predetermined sound from the speaker, and
controls the output unit to output, on the user interface, an image representing a view of a state where the button of the selected device to be subjected to setting is pressed.
   (13) The information processing apparatus according to any one of (1) to (12), in which

the communication unit is capable of communicating with a server on the network, which server mediates cooperation processing between the information processing apparatus and the device to be subjected to setting, and

the controller controls the output unit to output, by using the user interface that shows the list, a user interface for performing association setting between the information processing apparatus and the device to be subjected to setting, the association setting being necessary in starting the cooperation processing, after completing the initial setup.

### DESCRIPTION OF SYMBOLS

11 CPU
13 RAM
14 bus
16 display unit
17 operation receiving unit
18 storage unit
19 communication unit
21 LED display
22 button
50 WAN
100 UI execution device
101 device information listing/selecting module
102 device discovery client module
103 device information obtaining module
104 device-specifying instruction module
105 easy-setting processor
106 communication processor
107 device-specifying operation module
125 device-specifying information display area
150 wireless LAN
200 setting-sender device (access point)
300 (300C, 300D) device to be subjected to setting
400 (400A, 400E) device after setting
500 server

1. An information processing apparatus comprising:
a communication unit capable of communicating with a device to be subjected to setting, the device to be subjected to setting being a candidate for an initial setup for operating on a wireless communication network;
an output unit;
an operation receiving unit; and
a controller capable of
controlling the communication unit to search for the device to be subjected to setting,
controlling the output unit to output a user interface showing a list of information relating to the retrieved devices to be subjected to setting, and
controlling the operation receiving unit to accept an operation by a user to select, from the output list, the device to be subjected to setting for the initial setup.

2. The information processing apparatus according to claim 1, wherein
the controller
controls the communication unit to
send, to the selected device to be subjected to setting, a message requesting for approval for the initial setup, and
receive, from the selected device to be subjected to setting, a message indicating the approval, and
controls the output unit to output a piece of information indicating the approval.

3. The information processing apparatus according to claim 1, wherein
the communication unit is capable of communicating with an access point which stores setting information that is necessary for performing the initial setup, and
the controller controls the communication unit to send, to the access point, a message requesting for sending the stored setting information to the device to be subjected to setting.

4. The information processing apparatus according to claim 1, further comprising
a storage unit which stores setting information that is necessary for performing the initial setup, wherein
the controller controls the communication unit to encrypt and send the stored setting information to the selected device to be subjected to setting.

5. The information processing apparatus according to claim 1, wherein
the controller controls the output unit to output, on the user interface, text information or image information which can allow the user to identify the device to be subjected to setting.

6. The information processing apparatus according to claim 5, wherein
the communication unit is capable of communicating with a server on the network, which server stores the text information or the image information, and
the controller controls the communication unit to receive the text information or the image information from the server.

7. The information processing apparatus according to claim 1, wherein
the communication unit is capable of communicating with a device after setting, the initial setup of which has been completed, and
the controller controls the output unit to output the information relating to the device to be subjected to setting and information relating to the device after setting, in a distinguishable manner, on the user interface.

8. The information processing apparatus according to claim 1, wherein
the controller controls the communication unit to,
if the operation to select is accepted,
send a message requesting for outputting information that can be perceived by the user, to the selected device to be subjected to setting.

9. The information processing apparatus according to claim 8, wherein
the device to be subjected to setting has a light-emitting part, and
the controller controls the communication unit to send, to the selected device to be subjected to setting, a message requesting for changing a state of the light-emitting part.

10. The information processing apparatus according to claim 8, wherein
the device to be subjected to setting has a speaker, and
the controller controls the communication unit to send, to the selected device to be subjected to setting, a message requesting for outputting a predetermined sound from the speaker.

11. The information processing apparatus according to claim 8, wherein
the controller controls the output unit to output, on the user interface, an image representing a view of a state where the information that can be perceived is output from the device to be subjected to setting.

12. The information processing apparatus according to claim 1, wherein
the device to be subjected to setting has a button, and
the controller
controls the communication unit to send, to the selected device to be subjected to setting, a message requesting for outputting a predetermined sound from the speaker, and
controls the output unit to output, on the user interface, an image representing a view of a state where the button of the selected device to be subjected to setting is pressed.

13. The information processing apparatus according to claim 1, wherein
the communication unit is capable of communicating with a server on the network, which server mediates cooperation processing between the information processing apparatus and the device to be subjected to setting, and
the controller controls the output unit to output, by using the user interface that shows the list, a user interface for performing association setting between the information processing apparatus and the device to be subjected to setting, the association setting being necessary in starting the cooperation processing, after completing the initial setup.

14. An information processing method, comprising:
searching for a device to be subjected to setting which is a candidate for an initial setup for operating on a wireless communication network;
outputting a user interface showing a list of information relating to the retrieved devices to be subjected to setting; and
accepting an operation by a user to select from the output list the device to be subjected to setting for the initial setup.

15. A program, causing an information processing apparatus to execute the steps of:
searching for a device to be subjected to setting which is a candidate for an initial setup for operating on a wireless communication network;
outputting a user interface showing a list of information relating to the retrieved devices to be subjected to setting; and
accepting an operation by a user to select from the output list the device to be subjected to setting for the initial setup.
